(19) United States
(12) Patent Application Publication
(10) Pub. No.: US 2016/0034450 A1
(43) Pub. Date: Feb. 4, 2016

(54) COMPARISON OF CONTENT PRESENTED BY CLIENT DEVICES OPERATING IN DIFFERENT LANGUAGES FOR CONSISTENT CONTENT PRESENTATION

(71) Applicant: GOOGLE TECHNOLOGY HOLDINGS LLC, Mountain View, CA (US)

(72) Inventors: Tom T. Chin, San Jose, CA (US); Sushil Garg, Sunnyvale, CA (US); Janine S. Oliveira, Palo Alto, CA (US); Vineet K. Srivastava, Cupertino, CA (US)

(21) Appl. No.: 14/450,428

(22) Filed: Aug. 4, 2014

(51) Int. Cl. G06F 17/28

(52) U.S. Cl. CPC G06F 17/2854; G06F 17/28

(57) ABSTRACT

Information describing content presented in a source language and in a target language is captured and communicated to a review server. For example, the review server receives screen captures of content presented in the source language and of the content presented in the target language. The review server concurrently presents information describing the content presented in the source language with information describing the content presented in the target language to a reviewing user. From the presented information, the reviewing user identifies differences between the content presented in the source language and the content presented in the target language to the review server. For example, the reviewing user identifies linguistic differences between content presented in the source language and in the target language as well as functional problems impairing presentation of content in the target language.

### BACKGROUND

This disclosure generally relates to client device configuration, and more specifically to comparing content presented by client devices operating in different languages for consistency.

Client device manufacturers distribute client devices worldwide, providing users in multiple countries access to client devices. Because of this worldwide distribution of client devices, multiple versions of applications executing on the client device are developed for use on client devices in different countries. For example, an application executing on a client device is developed and distributed in multiple languages to allow users in various countries to access the functionality of the application.

When developing versions of an application for execution in various languages, an entity developing the application seeks to provide consistent presentation of information in the application across various languages. Conventionally, an entity initially develops an application providing content in a source language and subsequently develops versions of the application presenting content in various target languages. A reviewer fluent in a target language compares the content presented in the source language with the content presented in the target language and identifies discrepancies between the presented content to be corrected.

Conventionally, a reviewer comparing content in a source language to content in a target language is sent a client device presenting content in the source language and a client device presenting the content in the target language or is sent a client device presenting content in the target language and reviews the content in the target language without concurrently viewing the content in the source language. Although this allows the reviewer to accurately and thoroughly compare content presented in the source language with content presented in the target language, this conventional method is time consuming and results in significant time consumption for comparing source language content to target language content. In these conventional approaches, when a reviewer identifies a difference between source language and target language, the entity developing the application remedies the difference and sends the reviewer an updated version of the application. This increases the time needed to provide consistent presentation of content in applications configured to present content in different languages.

### BRIEF DESCRIPTION OF THE DRAWINGS

FIG. 1 is a block diagram of a system environment, in accordance with an embodiment.

FIG. 2 is a block diagram of a client device, in accordance with an embodiment.

FIG. 3 is an interaction diagram of a method for identifying differences between content presented by client devices configured to operate in different languages, in accordance with an embodiment.

FIG. 4 shows an example interface describing content presented in a source language and content presented in a target language, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

A review server receives information describing content presented in a source language and information describing content presented in a target language. In one embodiment, information describing content presented in the source language is received from a source client device, while information describing content presented in the target language is received from a target client device presenting content in the target language. The source client device and the target client device capture data describing presented content by executing locally stored instructions, and each communicate the captured data to the review server. For example, the review server receives screen captures of content presented by the source client device in the source language and by the target client device in the target language when an application is executed. Additional information describing the content presented by the source client device and by the target client device may also be received by the review server. For example, the review server receives information describing an order in which the content is presented or relationships between various portions of the presented content. However, in other embodiments, the review server receives information describing content presented in the source language and the information describing content presented in the target language from a single client device.

From the information describing the content presented in the source language and presented in the target language, the review server concurrently presents a subset of the content presented in the source language and a subset of the content presented in the target language are concurrently presented to a reviewing user (e.g., a user fluent in the target language). For example, the review sever presents a screen capture of content in the source language concurrently with a screen capture of the content presented in the target language, allowing the reviewing user to perform a comparison between the screen captures. The reviewing user identifies differences between the content presented in the source language and the content presented in the target language to the review server. Example differences between content presented in the source language and in the target language include linguistic differences from errors in translating the source language to the target language, errors from truncating content in the target language, errors in contextual information surrounding words or phrases in the target language, errors from failing to translate words or phrases from the source language to the target language, or spelling errors. Additionally, the reviewing user may identify functional errors in the target language where settings or configuration information to present data in the target language impair performance of an application presenting the content in the target language. The review server may communicate the identified differences between source language and target language content presentation to an entity for remedying the differences and allow the reviewing user to view content in the target language after it has been modified to remedy the identified differences.

### System Architecture

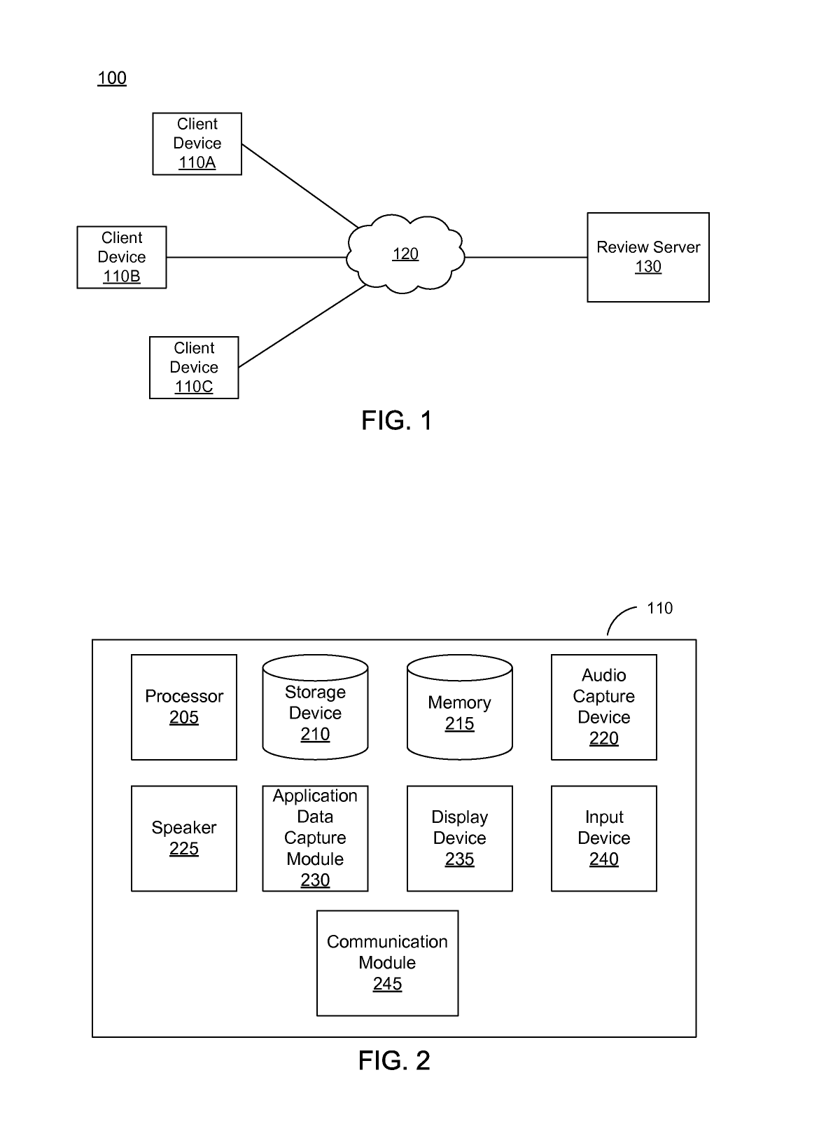

FIG. 1 is a block diagram of a system environment 100 including multiple client devices 110A, 110B, 110C (also referred to individually and collectively using reference number 110), a network 120, and a review server 130. In various embodiments, any number of client devices 110 are included in the system environment 100. Additionally, in alternative configurations, different and/or additional components may be included in the system environment 100.

A client device 110 is one or more computing devices capable of receiving user input as well as transmitting and/or receiving data via the network 120. In one embodiment, the client device 110 is a computer system, such as a desktop or a laptop computer. Alternatively, the client device 110 is any device with computing functionality, such as a personal digital assistant (PDA), a mobile telephone, a smartphone, a tablet computer or another suitable device. Each client device 110 may be associated with a user. For example, a client device 110 includes data identifying a user authorized to access the client device 110, limiting access to the client device 110 to the user providing identifying information matching the included data. A client device 110 may include instructions for executing one or more applications that modify data or exchange data with a content source (e.g., an application provider, a content provider, etc.). For example, the client device 110 executes a browser that receives content from a content source and presents the content to a user of the client device 110. In another embodiment, the client device 110 interacts with a content source through an application programming interface (API) running on a native operating system of the client device 110, such as IOS® or ANDROID™. An example client device 110 is further described below in conjunction with FIG. 2. While FIG. 1 shows three client devices 110A, 110B, 110C, in various embodiments, any number of client devices 110 may be included in the system environment 100.

Each client device 110 is associated with a language in which a client device 110 presents content to one or more users. In one embodiment, a client device 110 is associated with a location, which is associated with a language. For example, a client device 110 is associated with a location in which it is to be operated, so the client device 110 is associated with a language associated with the location. Content presented by a client device 110 is presented in the language associated with the client device 110. For example, the language associated with a client device 110 is the default language in which applications executing on the client device 110 present content. In some embodiments, a language associated with a client device 110 may be modified based on user-provided input.

The client devices 110A, 110B, 110C are configured to communicate with the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The review server 130 receives information from client devices 110 presenting content in different languages and generates information describing the content presented in various languages. Information generated by the review server 130 allows content presented in different languages by different client devices 110 to be compared to identify discrepancies between content presented in different languages. Identified discrepancies may then be remedied so content is accurately and consistently presented in various languages. Using information generated by the review server 130 to compare content presented in different languages allows the content to be compared without having direct physical access to multiple client devices 110 that each present content in a different language. For example, information generated by the review server 130 describing content presented in a source language and content presented in a target language is communicated to a linguist fluent in the target language to identify differences between content presented in the source language and content presented in the target language. In this example, the linguist may provide information identifying discrepancies between the content presented in the source language and the content presented in the target language to the review server 130, which communicates the identified discrepancies to one or more entities to modify subsequent presentation of content in the target language to remove the identified discrepancies.

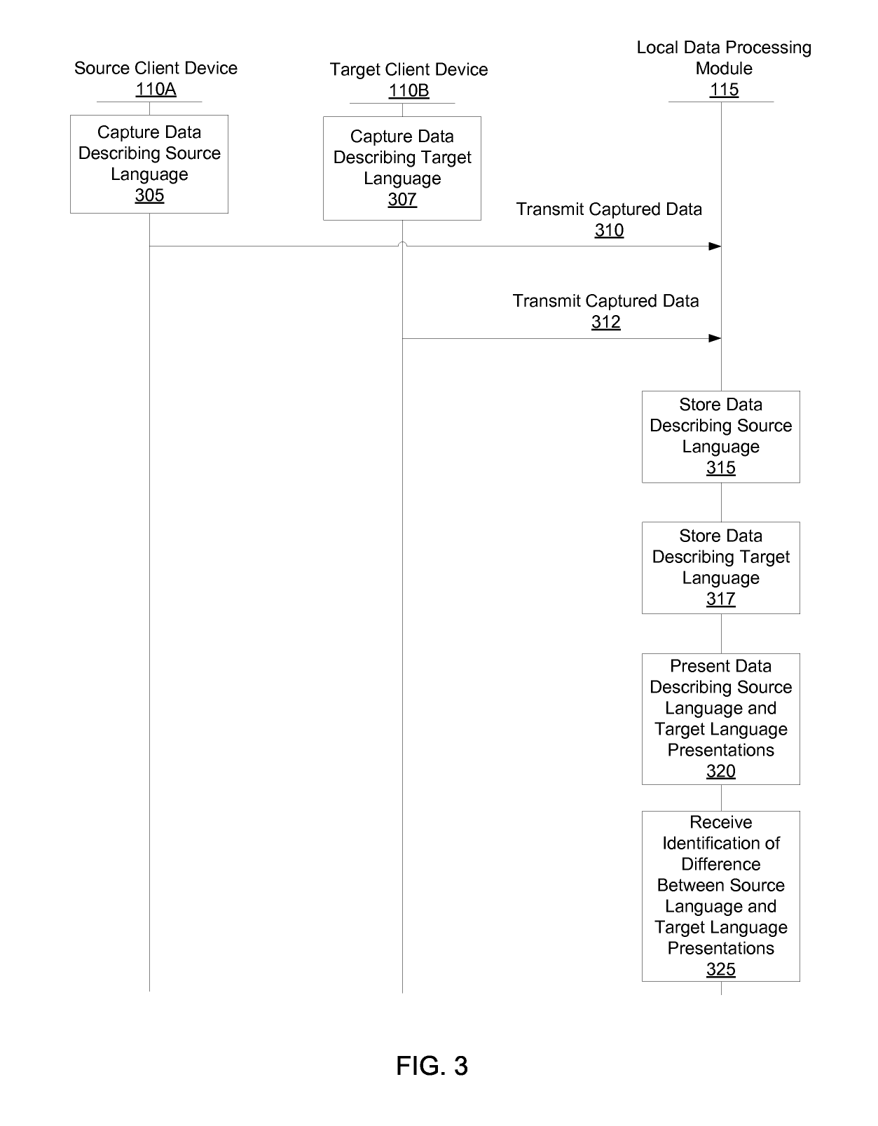

As further described below in conjunction with FIG. 3, the review server 130 receives information describing content presented by a source client device 110, which presents content in a source language, and information describing content presented by a target client device 110, which presents content in a target language. For example, the review server 130 receives screen captures of content presented by a client device 110 when an application is executed. Additionally, the review server 130 may receive additional information describing the presented content, such as an order in which the content is presented or a relationship of portions of the content to other portions of the content. The review server 130 retrieves information describing at least a subset of the content presented in the source language and information describing at least a subset of the content presented in the target language. For example, the review server 130 retrieves one or more screen captures of content presented in the source language and one or more screen captures of content presented in the target language. The subset of the content presented in the source language and the subset of the content presented in the target language are concurrently presented to a reviewing user (e.g., a user fluent in the target language), and the reviewing user identifies discrepancies between the content presented in the source language and the content presented in the target language to the review server 130. Operation of the review server 130 is further described below in conjunction with FIG. 3.

FIG. 2 is a block diagram of one embodiment of a client device 110. In the example shown by FIG. 2, the client device 110 includes a processor 205, a storage device 210, a memory 215, an audio capture device 220, a speaker 225, an application data capture module 230, a display device 235, an input device 240, and a communication module 245. However, in other embodiments, the client device 110 may include different and/or additional components than those described in conjunction with FIG. 2.

The client device 110 includes one or more processors 205, which retrieve and execute instructions from the storage device 210 or the memory 215. Additionally, a processor 205 receives information from the input device 230 and executes one or more instructions included in the received information. The storage device 210 is a persistent storage device including data and/or instructions for execution by the processor 205 or for presentation to a user of the client device. Examples of a storage device 210 include a solid-state drive, a flash memory drive, a hard drive, or other suitable persistent storage device.

The memory 215 stores instructions for execution by one or more processor 205. In various embodiments, the memory 215 is a volatile storage medium, while the storage device 210 is a non-volatile storage medium. Examples of a volatile storage medium include random access memory (RAM), static random access memory (SRAM), and dynamic random access memory (DRAM). Storing data or instructions in the memory 215 allows a processor 205 to retrieve the data or instructions more rapidly than data or instructions stored in the storage device 210. The data or instructions included in the memory 215 may be modified at various time intervals or in response to data received from a processor 205.

In one embodiment, the memory 215 is partitioned into a plurality of regions that are each associated with an identifier. For example, a slot represents a specified amount of the memory 215 and is associated with an address, allowing data stored in the slot to be retrieved using the address. Hence, different data may be stored in different slots and subsequently retrieved based on the identifiers associated with the slots.

The audio capture device 220 captures audio data and communicates the audio data to the processor 205, to the memory 215, or to any suitable component of the client device 110. For example, the audio capture device 220 comprises one or more microphones included in the client device 110. While FIG. 2 shows an example where the audio capture device 220 is included in the client device 110, in other embodiments, the audio capture device 220 may be external to the client device 110 and communicatively coupled to the client device 110. For example, the audio capture device 220 is a speaker and microphone system external to the client device 110 that exchanges information with the client device 110 via the network 120 or a connection to the client device 110.

The speaker 225 generates audio data based on information received or processed by the client device 110. For example, the client device 110 includes one or more speakers 225. While FIG. 2 shows an example where the speaker 225 is included in the client device 110, in other embodiments, the speaker 225 may be external to the client device 110 and communicatively coupled to the client device 110. For example, the speaker 225 is external to the client device 110 that exchanges information with the client device 110 via the network 120 or a connection to the client device 110. When the client device 110 receives audio data, the audio data is communicated to the external speaker 225.

The application data capture module 230 captures information describing data presented by one or more applications executing on the client device 110. For example, the application data capture module 230 obtains screen captures of content presented by an application via a display device 235. Additionally, the application data capture module 230 generates contextual information describing content presented by the application. For example, information describing an order in which content was presented by an application or information describing relationships between content presented by the application (e.g., an indication of content with which a user interacted prior to presentation of additional content) is generated by the application data capture module 230 and stored along with the information describing the presented content. In various embodiments, the application data capture module 230 comprises instructions that, when executed by a processor 205, cause the processor to capture content presented by an application executed by the processor 205. The application data capture module 230 may capture information in response to an instruction by a user to capture information.

A display device 235 presents content and other information to a user of the client device 110. Examples of the display device 235 include a liquid crystal display (LCD), an organic light emitting diode (OLED) display, an active matrix liquid crystal display (AMLCD), or any other suitable device. Different client devices 110 may have display devices 235 with different sizes, different resolutions, or other different characteristics.

For purposes of illustration, FIG. 2 shows a single input device 240; however, the client device 110 may include multiple input devices 240 in various embodiments. The input device 240 receives input from a user of the client device 110. Examples of the input device 240 include a touch-sensitive display, a keyboard, a dial pad, a mouse, and a trackpad. Using a touch-sensitive display allows the client device 110 to combine the display device 235 and the input device 240, simplifying user interaction with presented content. Inputs received via the input device 240 are be processed by the processor 205 and may be communicated to a content source, to the review server 130, or to another client device 110 via the communication module 245.

The communication module 245 transmits data from the client device 110 to the review serer 130, or to another client device 110 via the network 120. Additionally, the communication module 245 receives data via the network 120 (e.g., data from another client device 110 or from the review server 130) and communicates the received data to one or more components of the client device 110. For example, the communication module 245 is a wireless transceiver configured to transmit data using one or more wireless communication protocols. Example wireless communication protocols include: Global System of Mobile (GSM), Code Division, Multiple Access (CDMA), General Packet Radio Service (GPRS), third-generation (3G) mobile, fourth-generation mobile (4G), High Speed Download Packet Access (HSDPA), High Speed Uplink Packet Access (HSUPA), Long-Term Evolution (LTE) and Worldwide Interoperability for Microwave Access (WiMAX). In some embodiment, the communication module 245 enables connection to the network 120 through a wired communication protocol, such as Ethernet. While FIG. 2 shows a single communication module 245, multiple communication modules 245 may be included in a client device 110 in some embodiments.

### Validating Content Presented by Client Devices Operating in Different Languages

FIG. 3 is an interaction diagram of a method for identifying differences between content presented by client devices 110 configured to operate in different languages. While FIG. 3 shows an example involving two client devices 110A, 110B, in other embodiments, any number of client devices 110 may be involved. For example, a single client device 110 communicates information describing content presented in a source language and information describing content presented in a target language to a review server 130. As another example, a source client device 110A presents content in a source language, while multiple other client devices 110 present the content in various target languages. Additionally, in the example of FIG. 3 data is communicated from client devices 110 to a review server 130; however, in alternative embodiments, data may be communicated from the client device 110 to different review servers 130 or to any suitable entity. Additionally, other embodiments may include different or additional steps than those shown in FIG. 3.

In the example of FIG. 3, the source client device 110A presents content in a source language, while a target client device 110B presents content in a target language. For example, the source client device 110A presents content in English, while the target client device 110B presents content in Spanish. The source language may be a language in which an application or operating system was designed, while the target language is a language to which the application or operating system is to be translated.

The source client device 110A captures 305 data describing content presented by the source client device 110A in the source language, while the target client device 110B captures 307 data describing content presented by the target client device 110B presented in the target language. For example, the source client device 110A captures 305 screen captures of content presented by the source client device 110A and the target client device 110B captures 307 screen captures of content presented by the target client device 110B. In other embodiments, the source client device 110A captures 305 any suitable data describing content presented in the source language and the target client device 110B captures 307 any suitable data describing content presented in the target language. As described above in conjunction with FIG. 2, the source client device 110A executes stored instructions to capture 305 the data describing presented content and the target client device 110B executes stored instructions to capture 307 data describing presented content.

Data captured 305 by the source client device 110A describing presented content also includes additional information describing presentation of the content. In one embodiment, the captured data includes an order in which content was presented by the source client device 110A. For example, if the source client device 110A captures 305 screen captures of content, information describing the temporal order in which various screens of content were presented is also captured 305. Relationships between different portions of content presented by the source client device 110A may also be identified by the captured data. As an example, information identifying that interaction with a portion of content causes presentation of an additional portion of content is also maintained, allowing the captured data to more completely describe how content is presented. However, any suitable information describing presentation of content by the client device 110A may be captured 305. The target client device 110B similarly captures 307 the additional information describing its presentation of content.

The source client device 110A transmits 310 the captured data describing presentation of content in the source language to the review server 130 via the network 120, and the target client device 110B also transmits 310 the review server 130 the captured data describing presentation of content in the target language via the network 120. Data from the source client device 110A describing presentation of content in the source language is stored 315 by the review server 130. Similarly, the review sever 130 stores 317 data from the target client device 110B describing presentation of content in the target language.

Based on the stored data, the review server 130 presents 320 data describing presentation of content in the source language and presentation of content in the target language to a reviewing user, which may be a user fluent in the target language. For example, the reviewing user identifies a target language and requests comparison of content presented in the source language with presentation of the target language, and the review server 130 presents 320 data describing content presented in the source language with data describing content presented in the target language to the reviewing user. Hence, different reviewing users may identify different target languages from the review server 130, simplifying analysis of content presented in various target languages by reviewing users fluent in different target languages. The review server 130 may communicate a subset of the data describing presentation of content in the source language and a subset of the data describing presentation of content in the target language to a client device 110 associated with the reviewing user for presentation.

When presenting 320 data describing presentation of content in the source language and presentation of content in the target language, the review server 130 presents 320 data describing presentation of content in the source language concurrently with data describing presentation of content in the target language. For example, the review server 130 presents a screen capture of content presented in the source language concurrently with a screen capture of content presented in the target language. In this example, the screen capture of content presented in the source language may be presented side-by-side with the screen capture of content presented in the target language. This allows the reviewing user to easily identify differences or inconsistencies between content presented in the source language and content presented in the target language.

Additionally, the data presented to the reviewing user may include information describing an order in which content is presented or relationships between presented content. For example, in addition to presenting a screen capture of content presented in the source language concurrently with a screen capture of the content presented in the target language, the review server 130 also presents 320 information identifying content presented before or presented after the content presented in the screen captures. In some embodiments, title or a description of content presented before or after the content in the presented screen captures is presented 320 to provide an indication to the reviewing user of the content presented before or after the content in the screen captures. Alternatively, a screen capture or a partial screen capture presented before or after the screen captures presented 320 to the reviewing user is also presented 320 to provide the reviewing user with context surrounding the screen capture of content presented in the source language and the screen capture of content presented in the target language.

If the content presented in the source language differs from the content presented in the target language, the review server 130 receives 325 an identification of a discrepancy between the presentation of the content in the source language and the presentation of the content in the target language from the reviewing user. For example, if a word presented in the target language does not match a translation of a corresponding word presented in the source language or if a word was not translated from the source language to the target language, the review server 130 receives 325 an identification of the non-matching word in the target language. Additionally, if content presented in the target language differs from content presented in the source language because of configuration settings or other data for presenting content in the target language, the review server 130 receives 325 an indication that the content is incorrectly presented in the target language. The received indication may identify whether the discrepancy between source language and target language presentation is a linguistic discrepancy (e.g., a grammatical, translation, or truncation error) or is a functional discrepancy caused by one or more settings for presenting content in the target language. The review sever 130 may receive 325 information describing differences between individual portions of content presented in the source language and in the target language. For example, the received information describes differences between individual screen captures of content presented in the source language and presented in the target language.

The review server 130 communicates information describing the identified discrepancy to one or more entities to modify presentation of content in the target language to remedy the identified discrepancy. For example, the review server 130 identifies a discrepancy to an application developer associated with an application presenting the content. When identifying a discrepancy to an entity, the review server 130 may identify a type of discrepancy and may also include instructions for remedying the identified discrepancy.

If presentation of content in the target language is modified based on the identified discrepancy, the target client device 110B, or another suitable entity, captures data describing the modified presentation of the content in the target language and communicates 307 the data describing the modified presentation of the content in the target language to the review server 130. The data describing the modified presentation of the content in the target language is presented 320 to the reviewing user, who provides information indicating whether the discrepancy has been resolved. In some embodiments, the review server 130 identifies content presented in the target language that has been modified to allow a reviewing user to more easily identify modifications to content presented in the target language to compare the modified content to the content presented in the source language for accuracy.

If the content presented in the source language does not differ from the content presented in the target language, the review server 130 receives an indication that the content presented in the target language matches the content presented in the source language. The review server 130 may associate information with various content presented in the target language to indicate whether the content presented in the target language matches or differs from the content presented in the source language. The review server 130 may identify an amount of content presented in the target language matching, or differing from, the content presented in the source language. Based on the information associated with content presented in the target language, the review server 130 may generate a report specifying the percentage or amount of content presented in the target language matching the content presented in the source language or an amount or percentage of content presented in the target language differing from the content presented in the source language.

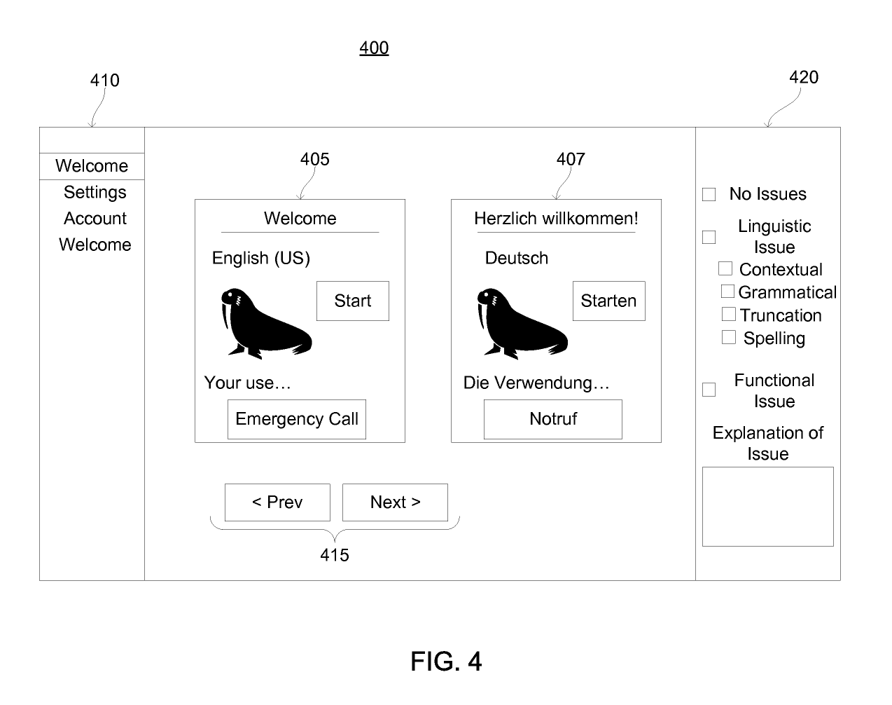

FIG. 4 shows an example interface 400 presented by the review server 130 describing content presented in a source language and content presented in a target language. In the example of FIG. 4, the interface 400 presents a screen capture 405 of content presented in a source language concurrently with a screen capture 407 of the content presented in a target language. For purposes of illustration, FIG. 4 shows a source language of English and a target language of German. As described above in conjunction with FIGS. 2 and 3, the screen capture 405 is received by the review server 130 from a source client device presenting content in the source language, while the screen capture 407 is received by the review server 130 from a target client device presenting content in the target language.

Presenting the screen capture 405 of content presented in the source language concurrently with the screen capture 407 of the content presented in the target language allows a reviewing user viewing the interface 400 to readily compare the content in the source and target languages. To provide additional context when comparing the screen capture 405 with the screen capture 407, the interface 400 in FIG. 4 also provides information 410 describing an ordering of content that is presented. In the example of FIG. 4, the information 410 identifies a temporal sequence in which content is presented relative to each other by presenting an ordered listing of titles or names of various content that is presented. For example, in FIG. 4, content corresponding to a screen capture titled “Welcome” is initially presented, when content corresponding to a screen capture titled “Settings” subsequently presented. A user viewing the interface may navigate between content presented in the target language and in the source language using one or more interface elements 415 presented by the interface. In the example of FIG. 4, the “next” interface element presents a subsequent pair of screen captures in the source language and in the target language (e.g., screen captures corresponding to the “Settings” title in the information 410 describing ordering of content in FIG. 4), while the “previous” interface element presents a preceding pair of screen captures in the source language and in the target language. The interface elements 415 allow a user to simply navigate through presented content to compare different portions of content presented in the source language and in the target language.

A notification region 420 receives input from a user describing one or more discrepancies between the content presented in the source language and the target presented in the target language. In the example of FIG. 4, the notification region 420 allows a user to specify whether a discrepancy between content presented in the source language and the content presented in the target language is a linguistic difference or a functional issue. If a word presented in the target language does not match a translation of a corresponding word presented in the source language, the user identifies the difference as a linguistic difference. Via the notification region 420, the user may provide information describing an identified linguistic difference. For example, the user may specify if a linguistic difference is caused by a contextual error, a grammatical error, a truncation error, or a spelling error. However, in other embodiments, any suitable information describing a linguistic difference may be provided. Additionally, the notification region 420 allows the user to identify a difference between content presented in the source language and the content presented in the target language is a functional difference affecting operation of the application presenting the content based on or more settings for presenting content in the target language. Via the notification region 420, a user may also provide an explanation of an identified difference between content presented in the source language and the content presented in the target language. For example, the user specifies instructions for remedying the identified difference or additional information describing the identified difference.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A system comprising:
a source client device configured to present content generated by an application in a source language and configured to capture data describing presentation of the content generated by the application in the source language;
a target client device configured to present content generated by the application in a target language and configured to capture data describing presentation of the content generated by the application in the target language;
a review server coupled to the source client device and to the target client device, the review server configured to receive the data describing presentation of the content generated by the application in the source language and to receive the data describing presentation of the content generated by the application in the target language, and the review server configured to present information from the data describing presentation of the content generated by the application in the source language concurrently with information from the data describing presentation of the content generated by the application in the target language.

2. The system of claim 1, wherein the review server is further configured to receive information describing one or more differences between information from the data describing presentation of the content generated by the application in the source language and the information from the data describing presentation of the content generated by the application in the target language.

3. The system of claim 2, wherein the information describing one or more differences between information from the data describing presentation of the content generated by the application in the source language and the information from the data describing presentation of the content generated by the application in the target language comprises an indication of whether a difference is a linguistic difference or an error in presenting content in the target language.

4. The system of claim 3, wherein the linguistic difference is selected from a group consisting of: a grammatical error, a truncation error, a translation error, a missing translation and a combination thereof.

5. The system of claim 2, wherein the information describing one or more differences between information from the data describing presentation of the content generated by the application in the source language and the information from the data describing presentation of the content generated by the application in the target language includes one or more instructions for remedying a difference.

6. The system of claim 1, wherein the data describing presentation of the content generated by the application in the source language comprises a screen capture of data presented in the source language and the data describing presentation of the content generated by the application in the target language comprises a screen capture of data presented in the target language.

7. The system of claim 6, wherein the review server is configured to present the screen capture of data presented in the source language concurrently with the screen capture of data presented in the target language.

8. The system of claim 6, wherein the review server is further configured to receive information describing one or more differences between the screen capture of data presented in the source language and information the screen capture of data presented in the target language.

9. The system of claim 1, wherein the data describing presentation of the content generated by the application in the source language includes information describing an order in which the data was presented by the source client device.

10. The system of claim 1, wherein the data describing presentation of the content generated by the application in the target language includes information describing an order in which the data was presented by the target client device.

11. A method comprising:
receiving data describing content presented in a source language;
receiving data describing the content presented in a target language;
storing the data describing the content presented in the source language and the data describing the content presented in the target language;
presenting information from the data describing the content presented in the source language concurrently with information from the data describing the content presented in the target language to a reviewing user; and
receiving information describing one or more differences between the content presented in the source language and the content presented in the target language identified by the reviewing user.

12. The method of claim 11, wherein the receiving information describing one or more differences between the content presented in the source language and the content presented in the target language comprises an indication of whether a difference is a linguistic difference or an error in presenting content in the target language.

13. The method of claim 11, wherein the linguistic difference is selected from a group consisting of: a grammatical error, a truncation error, a translation error, a missing translation, and a combination thereof.

14. The method of claim 11, wherein the receiving information describing one or more differences between the content presented in the source language and the content presented in the target language includes one or more instructions for remedying a difference.

15. The method of claim 11, wherein the data describing content presented in the source language comprises a screen capture of the content presented in the source language and the data describing content presented in the target language comprises a screen capture of the content presented in the target language.

16. The method of claim 15, wherein presenting information from the data describing the content presented in the source language concurrently with information from the data describing the content presented in the target language comprises:
presenting the screen capture of the content presented in the source language concurrently with the screen capture of the content presented in the target language.

17. The method of claim 16, wherein presenting information from the data describing the content presented in the source language concurrently with information from the data describing the content presented in the target language further comprises:
presenting information describing an order in which the content is presented in conjunction with the screen capture of the content presented in the source language concurrently presented with the screen capture of the content presented in the target language.

18. The method of claim 11, wherein the data describing content presented in the source language from the source client device includes information describing an order in which the content was presented in the source language.

19. The method of claim 11, wherein the data describing content presented in the target language from the target client device includes information describing an order in which the content was presented in the target language.

20. A computer program product comprising a computer-readable storage medium having instructions encoded thereon that, when executed by a processor, cause the processor to:
receive data describing content presented in a source language
receive data describing the content presented in a target language;
store the data describing the content presented in the source language and the data describing the content presented in the target language;
present information from the data describing the content presented in the source language concurrently with information from the data describing the content presented in the target language to a reviewing user; and
receive information describing one or more differences between the content presented in the source language and the content presented in the target language identified by the reviewing user.
